(19) United States
(12) Patent Application Publication
(10) Pub. No.: US 2020/0410513 A1
(43) Pub. Date: Dec. 31, 2020

(54) METHODOLOGY AND SYSTEM FOR LIGHTWEIGHT PERSONALIZED ANALYTICS

(71) Applicant: Sandra K. JOHNSON, Cary, NC (US)

(72) Inventor: Sandra K. JOHNSON, Cary, NC (US)

(21) Appl. No.: 16/914,629

(22) Filed: Jun. 29, 2020

Related U.S. Application Data
(60) Provisional application No. 62/868,950, filed on Jun. 30, 2019.

(51) Int. Cl. G06Q 30/02; G06F 16/23; G06Q 40/00; G06Q 50/00; G06Q 40/02; G06Q 20/02; G06Q 40/08; G06Q 30/00; G06Q 50/26; G06Q 20/10; H04L 29/08

(52) U.S. Cl. CPC G06Q 30/0201; G06F 16/2379; G06Q 40/12; G06Q 50/01; G06Q 40/02; G06Q 30/016; G06Q 40/08; G06Q 30/0185; G06Q 50/265; G06Q 20/108; H04L 67/22; G06Q 20/027

(57) ABSTRACT

An embodiment of the present invention is directed to providing lightweight personalized analytics (LPA). Disclosed embodiments include a process for leveraging behavioral and other analytics types, and using a small number of parameters, a small memory footprint and optimal computation, to deliver behavioral and other suggestions to customers based on insights. An objective is to minimize the parameters and optimize the insights and suggestions for customer behavior.

### CROSS REFERENCE TO RELATED APPLICATIONS

This application claims priority to U.S. Provisional Application 62/868,950, filed Jun. 30, 2019, the contents of which are incorporated herein in its entirety.

### FIELD OF THE INVENTION

The disclosed teachings relate generally to leveraging consumer data to conduct fast, behavioral analytics with a small footprint to gain personalized insights for actions. Potential participants include those in consumer-focused industries and entities, and analytics.

### BACKGROUND

Many consumer-based companies leverage customer data and associated predictive, prescriptive, and other analytic methodologies to gain insights. Such information can translate into suggestions to improve efficiencies, understand trends, create new potential markets, or discover or prevent fraud, to name a few. There is an abundance of analytics efforts conducted to gain such insights. With an increasingly consumer-centric society, there is a growing focus on behavioral analytics to understand customer preferences that can translate into market gains. Much of this work leverages a plethora of structured and unstructured data that may be siloed and geographically dispersed for insights.

There are many consumer-focused industries that require small, lightweight, and fast analytics. For example, the prevailing focus in the remittance industry is the transfer of funds from sender to receiver. The transfer amounts are small, and users require minimal transfer times. Moreover, with thin industry profit margins it is important that all efforts to assist in transferring funds are efficient, lightweight, and fast. In this and many other industries, there are no significant efforts to build customer relationships, understand their wants, needs and behaviors, and build customer loyalty. However, a study has shown that businesses that develop strong customer connections outperform their competitors by 85% in sales growth and more than 25% in gross margin.

There are some efforts to use analytics in the remittance industry. For example, current systems use analytics to understand global remittance market trends. Others use analytics to discover glitches or behavior anomalies and detect and prevent fraud. Most focus on overall trends and patterns, not individual behaviors, to gain insights for unique customer offerings. Currently, there are no efforts to develop lightweight personalized analytics methodologies to gain insights for customized services real time.

These and other drawbacks exist.

### SUMMARY OF THE INVENTION

Accordingly, one aspect of the invention is to address one or more of the drawbacks set forth above. An embodiment of the present invention is directed to a system for providing lightweight personalized analytics (LPA). The system comprises: a user interface that receives one or more inputs via an enterprise payments services bus; a remittance data store that stores and manages LPA metrics; and a lightweight personalized analytics engine comprising a computer processor and coupled to the user interface and the remittance data store, the computer processor configured to perform the steps of: receiving one or more customer parameters and remittance trends; accessing, via the remittance data store, one or more LPA metrics; the LPA metrics comprising a maximum number of local inputs, external inputs and financial inputs; accessing a customer specific local input parameter; processing a plurality of transaction data, milestone events, social media data, and geolocation events; and based on the processing step, generating a set of remittance suggestions and financial suggestions.

Another embodiment of the present invention is directed to method for providing lightweight personalized analytics (LPA). The method comprises the steps of: receiving one or more customer parameters and remittance trends; accessing, via a remittance data store, one or more LPA metrics; the LPA metrics comprising a maximum number of local inputs, external inputs and financial inputs, wherein the remittance data store stores and manages LPA metrics; accessing a customer specific local input parameter; processing, via a lightweight personalized analytics engine, a plurality of transaction data, milestone events, social media data, and geolocation events; and based on the processing step, generating, via a user interface, a set of remittance suggestions and financial suggestions, wherein the user interface receives one or more inputs via an enterprise payments services bus.

According to another embodiment of the present invention, a computer-readable medium comprising instructions which, when executed by a computer, cause the computer to carry out steps of: receiving one or more customer parameters and remittance trends; accessing, via a remittance data store, one or more LPA metrics; the LPA metrics comprising a maximum number of local inputs, external inputs and financial inputs, wherein the remittance data store stores and manages LPA metrics; accessing a customer specific local input parameter; processing, via a lightweight personalized analytics engine, a plurality of transaction data, milestone events, social media data, and geolocation events; and based on the processing step, generating, via a user interface, a set of remittance suggestions and financial suggestions, wherein the user interface receives one or more inputs via an enterprise payments services bus.

The computer implemented system, method and medium described herein provide unique advantages to entities, organizations, merchants and other users (e.g., consumers, etc.), according to various embodiments of the invention. An embodiment of the present invention is directed to providing lightweight personalized analytics (LPA). The various embodiments include a process for leveraging behavioral and other analytics types, and using a small number of parameters, a small memory footprint and optimal computation, to deliver behavioral and other suggestions to customers based on insights. An objective is to minimize the parameters and optimize the insights and suggestions for customer behavior. These and other advantages will be described more fully in the following detailed description.

### BRIEF DESCRIPTION OF THE DRAWINGS

To facilitate a fuller understanding of the present inventions, reference is now made to the appended drawings. These drawings should not be construed as limiting the present inventions but are intended to be exemplary only.

FIG. 1 is a block diagram of a remittance payments service-oriented architecture, in accordance with exemplary embodiments of the disclosure.

FIG. 2 is a block diagram of a remittance data storage, in accordance with exemplary embodiments of the disclosure.

FIG. 3 is a block diagram of the types of data stored in a remittance data storage, in accordance with exemplary embodiments of the disclosure.

FIG. 4 is a block diagram of the lightweight personalized analytics (LPA) engine, in accordance with exemplary embodiments of the disclosure.

FIGS. 5a, 5b, 5c, 5d, 5e, and 5f are flowcharts illustrating an exemplary method for processing in the LPA engine, in accordance with exemplary embodiments of the disclosure.

FIGS. 6a, 6b, and 6c are flowcharts illustrating an exemplary method for processing in the LPA engine, in accordance with exemplary embodiments of the disclosure.

FIGS. 7a and 7b are flowcharts illustrating an exemplary method for processing in the LPA engine, in accordance with exemplary embodiments of the disclosure.

### DESCRIPTION OF EMBODIMENTS OF THE INVENTION

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to a methodology for lightweight personalized analytics (LPA), a new innovative technology designed to provide individual analytics to gain insights for developing personalized offerings to build relationships with the customer. LPA leverages a limited number of customer-specific, industry-focused input parameters, other inputs and a small footprint.

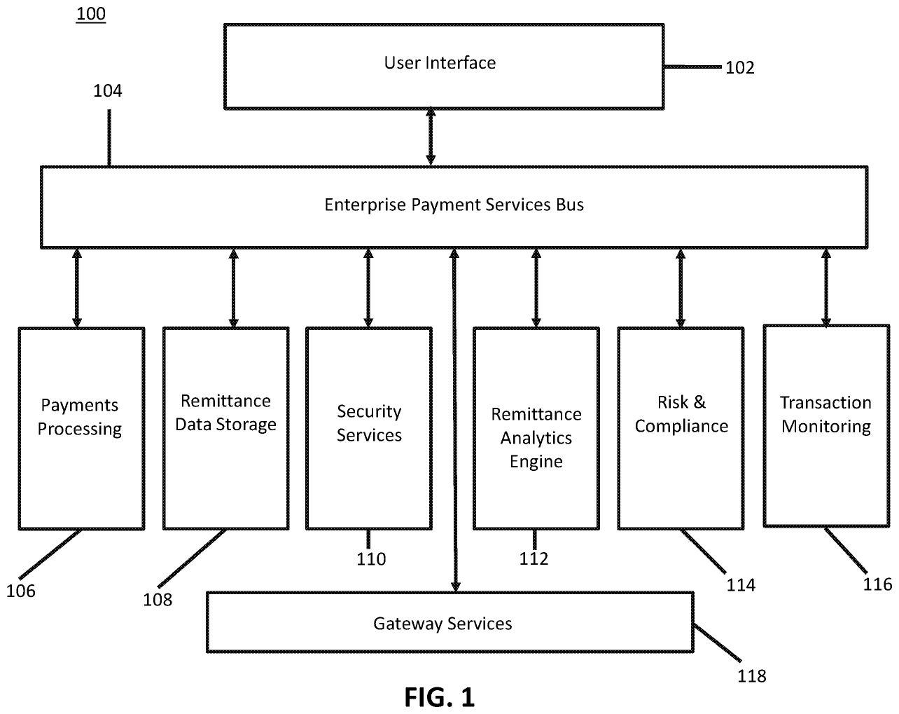

FIG. 1 is a block diagram of a remittance payments service-oriented architecture, in accordance with exemplary embodiments of the disclosure. FIG. 1 is a schematic block diagram illustrating a service-oriented architecture (SOA) 100 of a remittance system designed to process transactions, in accordance with an embodiment of the present invention. The system 100 includes a user interface 102 that enables a user to send or receive requests, etc. The user interface 102 may interact with enterprise payments services bus 104 to request or receive services. The enterprise payments services bus 104 may be configured to transmit data between engines, databases, memories, and other components of the system 100 for use in performing the functions discussed herein.

The enterprise payments services bus 104 may include one or more communication types and utilize various communication methods for communications within a computing device. For example, the enterprise payments services bus 104 may include a bus, contact pin connectors, wires, etc. In some embodiments, the enterprise payments services bus 104 may also be configured to communicate between internal components of system 100 and external components accessible through gateway services 118, such as externally connected databases, display devices, input devices, etc.

There are several services that may compose this SOA 100, including payments processing 106, remittance data storage 108, security services 110, the remittance analytics engine 112, risk and compliance 114, transaction monitoring 116, and gateway services 118, which are described below. Each of these service components may be software, a computer-readable program, executing on one of more processors and may include a mainframe computer, a workstation, a desktop computer, a computer in a smart phone, a computer system in a rack, a computer system in a cloud, a physical system, a virtual system, etc.

According to an embodiment of the present invention, system 100 may represent the SOA of a remittance system and a network of software service components in which the illustrative embodiments may be implemented. The system 100 includes a user interface 102 used by a consumer. The consumer may represent a person, a software program, a virtual program, or any other entity that has possession of, can emulate, or other otherwise issue commands to execute transactions in the system 100. The system 100 may include an enterprise payment services bus 104 which accepts and processes commands from the user interface 102 and other system components. It may also enable communication among the various services components in the system 100.

As a part of executing a remittance request, the transaction may leverage payments processing 106 to process the request. The transaction may also access remittance data storage 108 which is a resource for data access. Security services 110 may also be leveraged to ensure the full security and integrity of funds and data, and to detect and prevent fraud. In addition, the remittance analytics engine 112 may be leveraged and is the foundation for LPA. This engine may take as input a plethora of information from the remittance data storage 108 and other components that may enable the remittance analytics engine 112 to optimize its outputs. The risk and compliance 114 service provides customer identification, verification and other similar services required to comply with relevant governmental regulations and to minimize risk. The transaction monitoring 116 service tracks funds transfer behavior and other activities to detect anomalies that may point to fraud. It may work in concert with security services 110.

Gateway services 118 may enable the transfer of funds, data, requests, etc. to externally connected entities for further processing. Such entities may include a computer network, a financial institution, and others that may participate in end-to-end remittance or other funds transfer or data services. Other similar embodiments will be apparent to persons having skill in the relevant art.

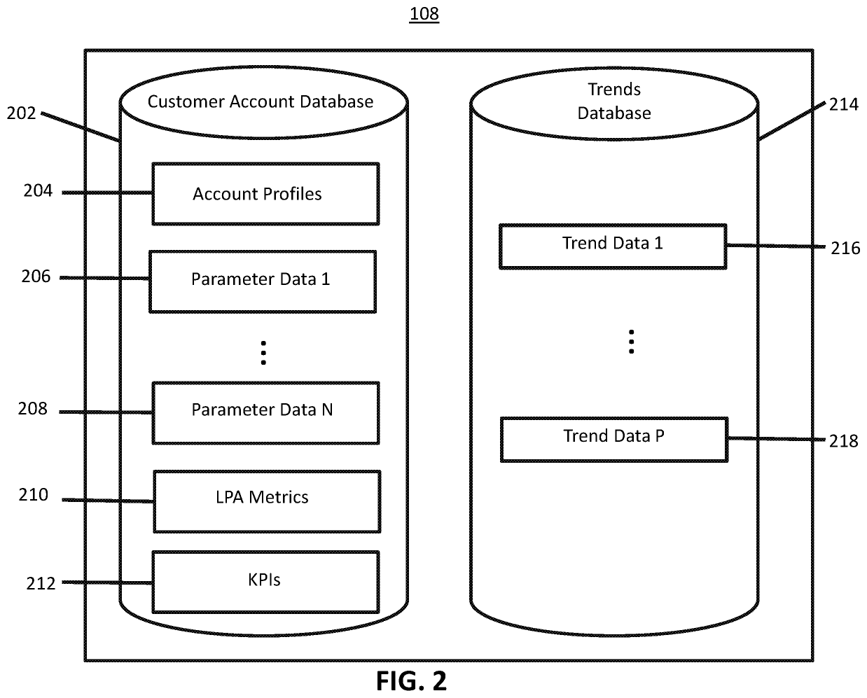

FIG. 2 is a block diagram of a remittance data storage, in accordance with exemplary embodiments of the disclosure. FIG. 2 is a schematic block diagram illustrating an embodiment of the remittance data storage service 108 used in the processing of information requests. The remittance data storage 108 may be a relational database, or a collection of relational databases, that utilizes structured query language for the storage, identification, modifying, updating, accessing, etc. of structured data sets stored therein. This data storage 108 may be composed of a customer account database 202 that contains customer account and other related customer information. The customer account database 202 may be configured to store a plurality of consumer account profiles 204 as well as a plurality of customer parameter data 206 and 208 using a suitable data storage format and schema.

Each customer account profile 204 may be a structured data set configured to store data related to a remittance account. Each customer account profile 204 may include at least the customer's full name, address, telephone number, birthdate, birth country, a remittance account number, a bank account number, credit card account information, email address, a list of recipients and associated international mobile telephone numbers, remittance transaction history, a postal mailing address, an email address, and other relevant information. The customer account profile 204 may also include additional information suitable for customer service programs, customer and vendor optimizations, and regulations, such as product data, offer data, loyalty data, reward data, usage data, currency-exchange data, mobile money data, fraud scoring, validity of funds, and transaction/account controls. The customer account profile 204 may also include additional information that may be required for know-your-customer (KYC) and anti-money laundering (AML) regulations. It may further contain information suitable for performing the functions discussed herein, such as communication details for transmitting via the enterprise payment services bus 104.

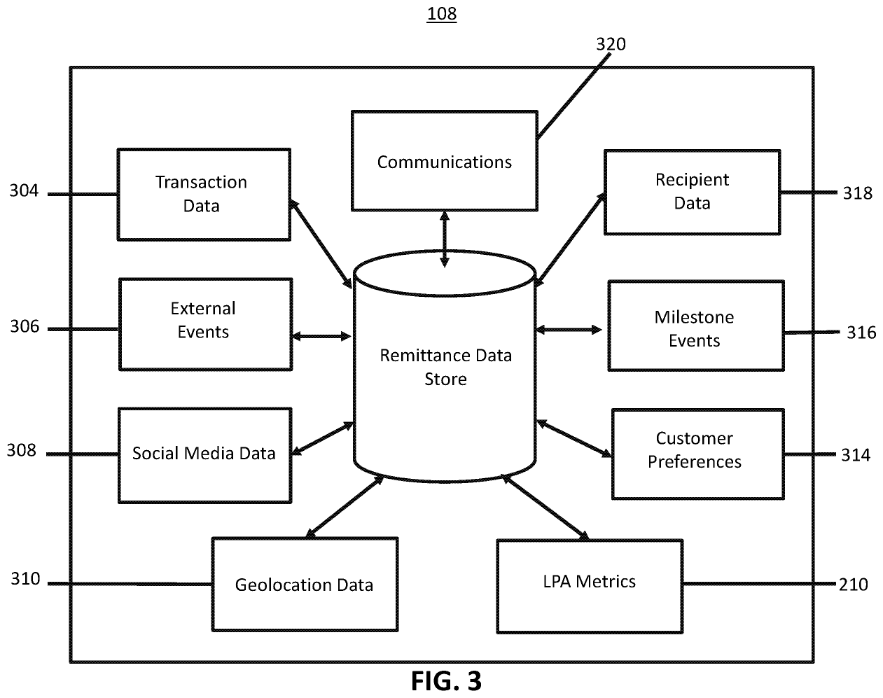

The customer parameter data 206 and 208 may be a wealth of various types of facts or other data (see FIG. 3) about the customer that may be used as input or output information for the remittance analytics engine 112. The customer account database 202 may also include LPA metrics 210 designed to quantify success. Example metrics may include the recommendation acceptance rate (RAR), financial services acceptance rate (FSAR), other services acceptance rate (OSAR), the local/global fraction of analytics inputs, the number of local inputs, the number of global inputs, the maximum number of input variables, the maximum analysis time, the maximum footprint, a list of targeted analytics algorithms, a list of past suggestions, the number, maximum and top M relevant factors and the number, maximum and top N relevant outcomes. The customer parameter data 206 and 208 may also include the customer temperament information, which may be predicted via social media data 308 or the number of times the customer contacts support, for example. Furthermore, the customer account database 202 may include key performance indicators (KPIs) 212. Example KPIs 212 are the increased number or frequency of remittances, remittance amounts, recipients, recipient communication and financial or other accounts.

Also contained in the remittance data storage 108 is the trends database 214. It contains a diverse collection of trend data 216 and 218. Examples of trend data may include average remittance amounts over all customers, remittance frequencies and time frames, remittance geographies, remittance increases over holidays or special occasions, and other similar metrics. Other similar embodiments will be apparent to persons having skill in the relevant art.

FIG. 3 is a block diagram of the types of data stored in a remittance data storage, in accordance with exemplary embodiments of the disclosure. FIG. 3 presents a schematic block diagram illustrating specifics regarding the plurality of data that may be stored in the remittance data storage 108. This data may be stored as structured data sets that may include transaction data 304, external events data 306, social media data 308, geolocation data 310, LPA metrics 210, customer preferences 314, milestone events 316, recipient data 318 and communications data 320.

Exemplary transaction data 304 may include the transfer amount, transfer time, recipient name and international mobile number, the time period since the last transfer initiated by the sender to any receiver, time period since the last transfer initiated by the sender to a specific receiver, and the final status of a transaction (e.g., completed, cancelled, etc.). Additional data may include metrics to quantify customer sentiments such as the number of times or frequency that the customer contacted support, time with support, and support outcomes. Exemplary external events 306 may include general remittance transaction data (transfer amounts, frequency, etc.) for other customers using the specific remittance service or for remittance customers using any remittance service, public holidays for the sender and receiver countries, natural disasters, immigration policies, the price of oil, global and local recessions.

Exemplary social media data 308 may include SMS messages exchanged between sender and receiver, between sender and the remittance service provider and between receiver and remittance service provider, and social media posts (e.g., Facebook, Twitter, Instagram, LinkedIn, etc.). Exemplary geolocation data 310 may include the physical location of sender and receiver when the funds transfer is initiated or received or the physical location of the sender or receiver at specific or random times. Other similar embodiments will be apparent to persons having skill in the relevant art.

Exemplary customer preferences 314 may be from the perspective of the sender. They may include hobbies, favorite things to do and financial preferences. Furthermore, LPA enables the creation of a financial or other count by the customer to save for the future. This account may be created and funded either statically or dynamically. A customer preference 314 may include the customer's desire to create a separate account (or some other activity) based on LPA analytics, to choose the type of account to create and to determine how to fund the account. A customer preference 314 may be to create a financial or other account when registering for the remittance service, or upon LPA recommendations when using the remittance service. There are many types of accounts to be created. The customer may choose between creating a bank account for education, starting a business, donating to a charity or some other option for the sender and/or the receiver. The choices may be general (e.g., the same type of account for sender and each recipient) for each recipient, or variable (e.g., a different type of account depending on the recipient or a group of recipients). Other similar embodiments will be apparent to persons having skill in the relevant art.

Exemplary milestone events 316 may include birthdays, including milestone birthdays (e.g., 18, 25, 30, etc.), weddings, anniversaries, graduations, and other special days for the sender or receiver. Example recipient data may include full name, international telephone number and recipient preferences that are like customer preferences 314. Communications data 320 may include the recent types of communications between sender, receiver, the remittance service provider, and external entities. Other similar embodiments will be apparent to persons having skill in the relevant art.

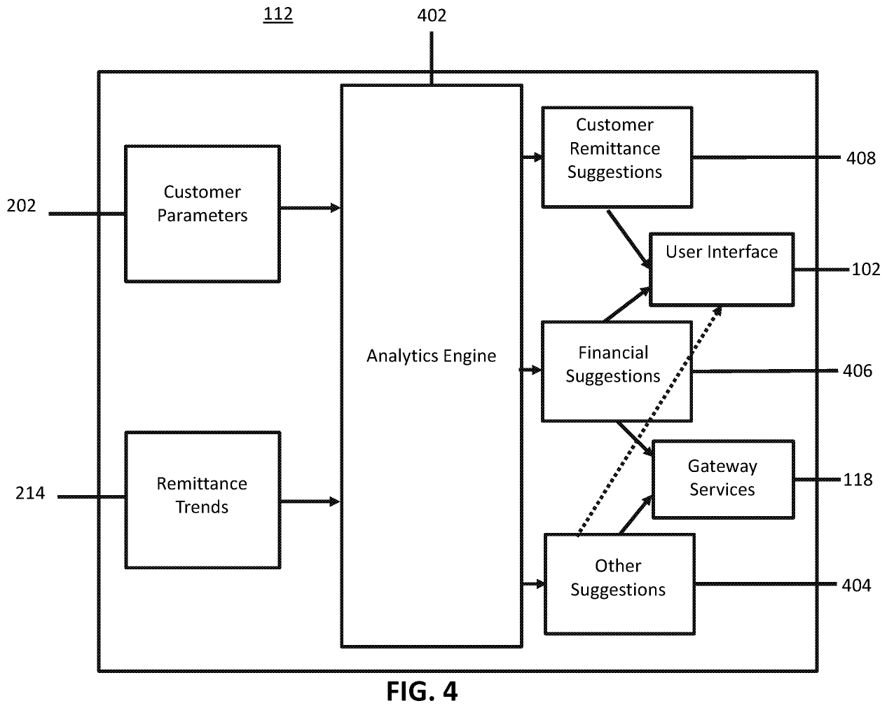

FIG. 4 is a block diagram of the lightweight personalized analytics (LPA) engine, in accordance with exemplary embodiments of the disclosure. FIG. 4 is a schematic block diagram illustrating an embodiment of the remittance analytics engine 112, the foundation for LPA. It may include the analytics engine 402, which accepts customer parameters 202 and remittance trends 214 as input. Outputs for the analytics engine 402 may include customer remittance suggestions 408, financial suggestions 406 and other suggestions 404.

The customer remittance suggestions 408, financial suggestions 406 and other suggestions 404 may communicate their suggestions to the customer through the user interface 102. The financial suggestions 406 and other suggestions 404 may communicate their suggestions to external entities (e.g., banks) via gateway services 118.

The analytics engine 402 may be the primary computational engine for leveraging predictive, customer behavioral and other analytics techniques for optimal customer remittance suggestions 408, financial suggestions 406 and other suggestions 404 for LPA. It may further utilize a plurality of customer parameters 202 and remittance trends 214 as input for its calculations. The number of these input factors may be constant or change dynamically and may depend on how they optimize the plurality of outcomes.

Customer remittance suggestions 408 may include recommendations for sending additional funds to one or a plurality of recipients, increasing the frequency of sending funds to one or a plurality of recipients, or other similar suggestions. Moreover, the customer may agree to specific transfer amounts and frequency, based on certain analytics triggers, upon customer registration, by default or dynamically. Financial suggestions 406 may include creating one or a plurality of finance accounts, based on customer preferences 314. The type and number of accounts may be determined upon customer registration for the remittance service, by default, or dynamically. The number, type, or frequency of other suggestions 404 may be determined in a similar manner.

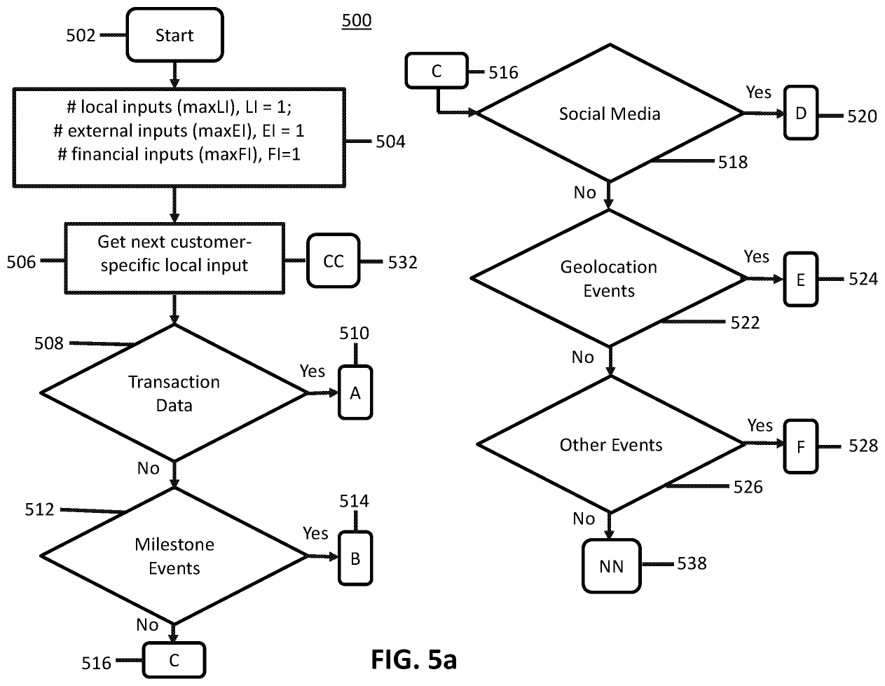

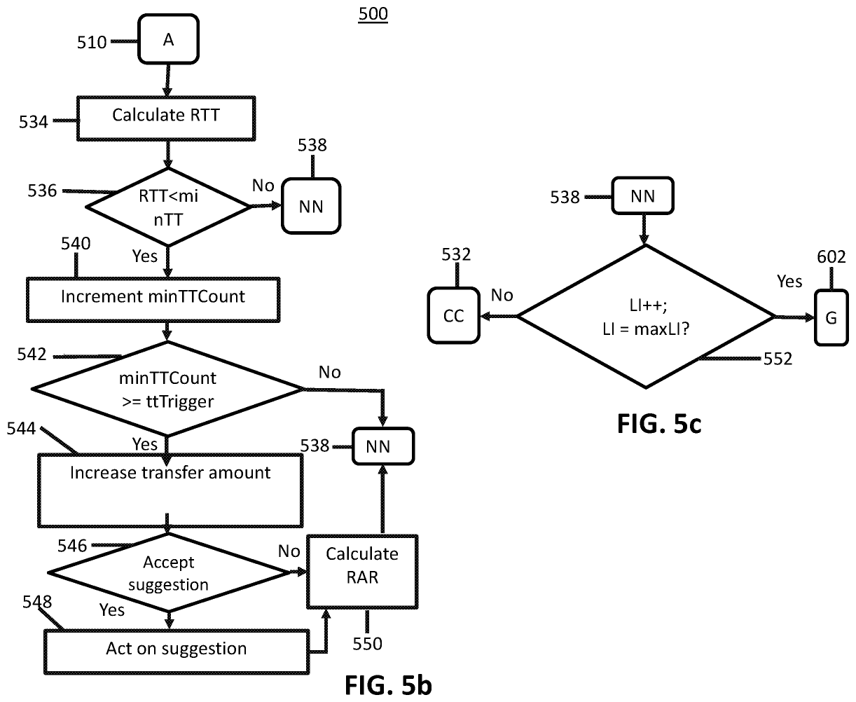

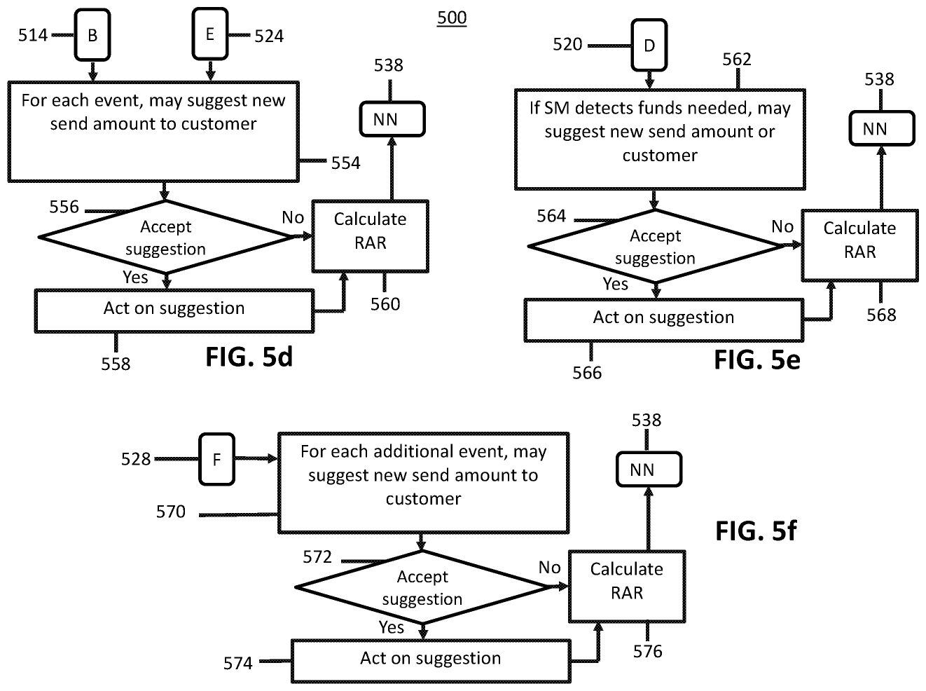

FIGS. 5a, 5b, 5c, 5d, 5e, and 5f are flowcharts illustrating an exemplary method for processing in the LPA engine, in accordance with exemplary embodiments of the disclosure. FIG. 5a is a flow chart illustrating an embodiment of the method to implement 500 the analytics engine 402. The method is started 502 by accessing several LPA metrics from the remittance data store 108. This may include the maximum number of local inputs, external inputs, and financial inputs 504. Internal engine parameters, number of local inputs (LI), external inputs (EI) and financial inputs (FI) may be set to 1, at 504. Next, the first customer specific local input parameter 506 may be accessed. Step 508 may determine whether the parameter qualifies as transaction data. If yes, then the flow moves to process the transaction data algorithms 510. If no, an embodiment of the present invention may determine whether the parameter qualifies as milestone events 512? If yes, then the flow moves to process the milestone events algorithms 514. If no, then the flow moves to process the next type of parameter 516. This next step may determine whether the parameter qualifies as social media 518? If yes, then the flow moves to process the social media algorithms 520. If no, then step 522 determines whether the parameter qualifies as geolocation events. If yes, then the flow moves to process the geolocation events 524. If no, step 526 determines if there other events to process. If yes, then the flow initiates processing at 528. If no, then the flow proceeds to the next step 538 (also FIG. 5c). This next step 538 may increment the internal number for local inputs and check to see if the maximum number of input parameters have been processed for the specific customer 552. If yes, the flow proceeds to the next component of the algorithm 602. If no, the next customer-specific local input parameter may be retrieved to process at 532.

FIG. 5b is the flow chart for processing the transaction data algorithms, which begins with 510. The time between customer transfers to a specific recipient (RTT) 534, and other similar metrics, may be calculated. Next, RTT may be compared to the minimum designated times between customer transfers to a specific recipient (minTT). If RTT is less than minTT 536, then step 540 increments the count on the number of times the minimum time between customer transfers to a specific recipient is less than minTT (minTTCount). Otherwise (no for 536) the flow proceeds to the next step 538. If minTTCount is greater than or equal to the maximum number of times funds are transferred in a short time before a suggested action (ttTrigger) 542, then step 544 increases the amount of a regular recurring transaction amount sent from the customer to the recipient. Otherwise (no for 542) the flow proceeds to the next step 538. The increased transfer amount 544 may then be suggested to the customer as the new transfer amount. Step 546 may determine whether the customer accepts this suggestion. If yes, then the remittance service acts on this suggestion 548 by making this suggested transfer amount the new amount to be regularly transferred to the recipient. If not (no for 546), then step 550 calculates a recommendation acceptance rate (RAR). Also, once the remittance service acts on the suggestion 548, the next step is to calculate the RAR 550. After this, the flow proceeds to the next step 538.

This illustrates an exemplary embodiment of how the transaction data may be processed. Other methods may be applied. In addition, there are many analytics algorithms, and associated parameters and metrics that may be used to process transaction data. Other similar embodiments will be apparent to persons having skill in the relevant art.

Presented in FIG. 5d is the continuing flow for processing milestone events 514 and geolocation events 524. For each event, a new regular send amount may be suggested to the customer 554. If the customer accepts the suggestion 556, then the remittance service may act on the suggestion 558, the RAR may be calculated 560, and the flow moves to the next step 538. Otherwise (no in 556) the RAR may be calculated 560 and the flow moves to the next step 538.

Presented in FIG. 5e is the continuing flow for processing social media (SM) events 520. There are many methods in which social media may determine when additional funds may be needed. When this happens, a new send amount may be recommended to the sender 562. If the customer accepts the suggestion 564, then the remittance service acts on the suggestion 566, the RAR is calculated 568, and the flow moves to the next step 538. Otherwise (no in 564) the RAR is calculated 568 and the flow moves to the next step 538.

Presented in FIG. 5f is the continuing flow for processing other events 528. There are many analytical methods to determine when additional funds may be needed for various additional events. When this happens, then a new send amount may be recommended to the sender 570. If the customer accepts the suggestion 572, then the remittance service acts on the suggestion 574, the RAR may be calculated 576, and the flow moves to the next step 538. Otherwise (no in 572) the RAR may be calculated 576 and the flow moves to the next step 538.

There are many ways to suggest new send amounts using analytics, whether it be behavioral or other types of analytical algorithms. These various embodiments may be leveraged as part of this process. Furthermore, the recommended send amount is an example embodiment of a parameter that may be adjusted. Various other parameters may be leveraged in a similar method in other embodiments, which will be apparent to persons having skill in the relevant art.

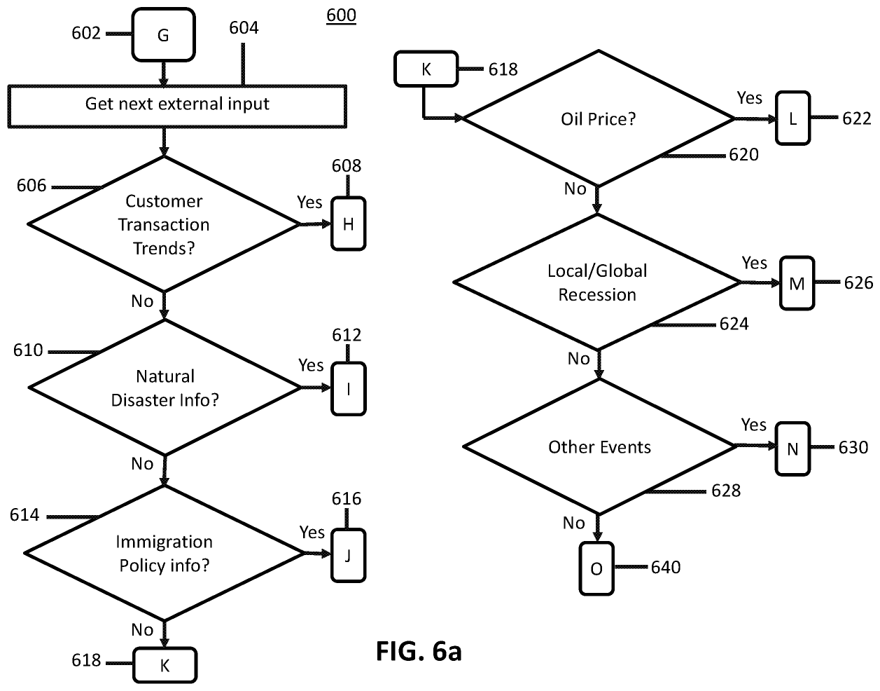

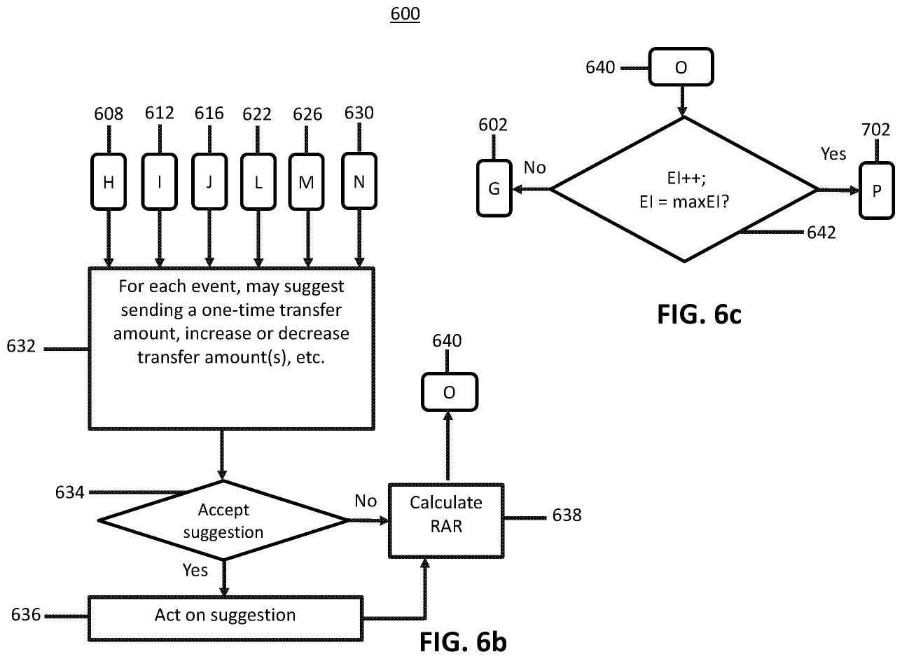

FIGS. 6a, 6b, and 6c are flowcharts illustrating an exemplary method for processing in the LPA engine, in accordance with exemplary embodiments of the disclosure. Illustrated in FIG. 6a is the flow chart for processing the external input parameters 600. It starts 602 by getting the next external input 604. Step 606 may determine whether this input parameter qualifies as customer transaction trends. If yes, step 608 may process these parameters 608. If no, step 610 may determine whether this parameter qualifies as natural disaster information. If yes, step 612 may process these parameters. If no, step 614 may determine whether immigration policy information applies. If yes, step 616 processes these parameters. If no, then the flow moves to the next parameter to evaluate 618. Step 620 may determine whether this parameter relates to the price of oil. If yes, step 622 may process this parameter. If no, step 624 may determine whether this relates to local or global recession information. If yes, step 626 may process these parameters. If no, step 628 may determine whether there are other events to process. If yes, then step 630 may process the events. If no, the flow may proceed to the next step 640 (FIG. 6c). This step may increment the internal number for external inputs and check to see if the maximum number of input parameters have been processed for the specific customer 642. If yes, then go to the next component of the algorithm 702. If no, then get the next customer-specific external parameter to process 602.

Presented in FIG. 6b is the continuing flow for processing customer transaction trends 608, natural disaster information 612, immigration information 616, the price of oil 622, local/global recession 626 and other events 630. There are many analytical methods used to determine when additional funds may be needed, whether one-time or recurring, for these various events. When this happens, a new send amount may be recommended to the sender 632. If the customer accepts the suggestion 634, then the remittance service acts on the suggestion 636, the RAR may be calculated 638, and the flow moves to the next step 640. Otherwise (no in 634) the RAR may be calculated 638 and the flow moves to the next step 640.

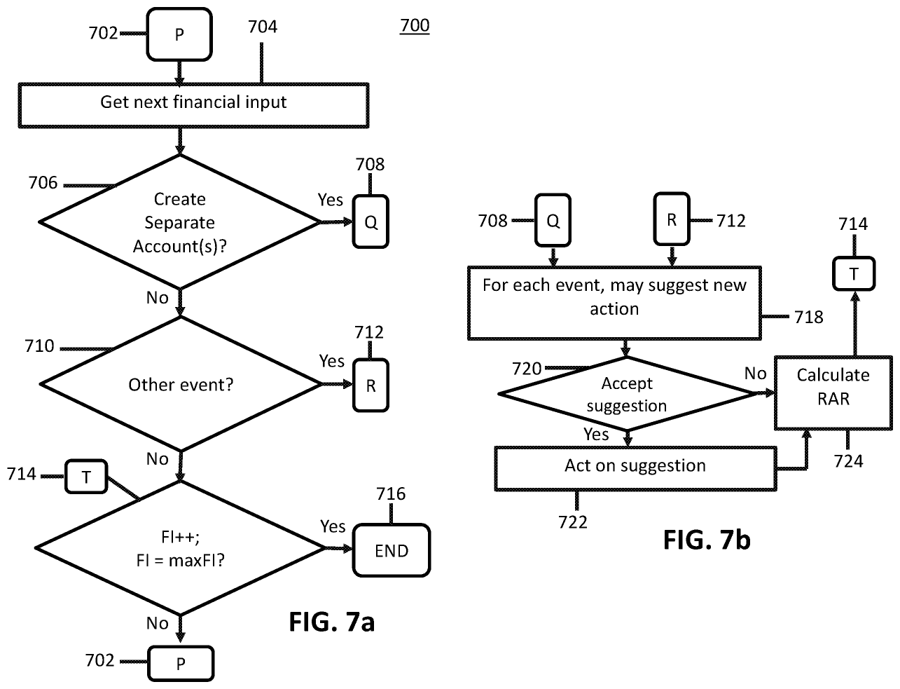

FIGS. 7a and 7b are flowcharts illustrating an exemplary method for processing in the LPA engine, in accordance with exemplary embodiments of the disclosure. Presented in FIG. 7a is the flow chart for processing the financial input parameters 700. It starts 702 by getting the next financial input 704. Step 706 may determine whether an input parameter creates separate account(s). If yes, step 708 may process the parameter. If no, step 710 may determine whether there are other financial events to process. If yes, step 712 may process the events. If no, step 714 may increment the internal number for financial inputs and check to see if the maximum number of input parameters have been processed for the specific customer. If yes, this process ends at 716. If no, step 702 may get the next financial parameter to process.

Shown in FIG. 7b is the continuing flow for processing separate financial accounts 708 or some other financial event 712. There are many analytical methods used determine when an additional account may be needed, when additional funds need to be added to such an account, whether one-time or recurring 708, or when some other type of financial account or event is required (e.g., transfer funds from separate account to receiver) 712. When this happens, then a new suggestion is made to the sender 718 to create the account, add additional funds, send funds to the receiver, etc. If the customer accepts the suggestion 720, then the remittance service acts on the suggestion 722, the RAR may be calculated 724, and the flow moves to the next step 714. Otherwise (no in 720) the RAR may be calculated 724 and the flow moves to the next step 714.

As with internal and external events, there are many ways to suggest the creation or funding of financial accounts using analytics, whether it be behavioral or other types of analytical algorithms. These various embodiments may be leveraged as part of this process. Furthermore, the recommendations shown are examples in this embodiment and may be enhanced. Various other parameters and suggestions may be leveraged in a similar method in other embodiments, which will be apparent to persons having skill in the relevant art.

Reference throughout this specification to “one embodiment,” “an embodiment,” or similar language means that a feature, structure, or characteristic described about the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labelled as modules, to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

1. A system for providing lightweight personalized analytics (LPA), the system comprising:
a user interface that receives one or more inputs via an enterprise payments services bus;
a remittance data store that stores and manages LPA metrics; and
a lightweight personalized analytics engine comprising a computer processor and coupled to the user interface and the remittance data store, the computer processor configured to perform the steps of:
receiving one or more customer parameters and remittance trends;
accessing, via the remittance data store, one or more LPA metrics; the LPA metrics comprising a maximum number of local inputs, external inputs and financial inputs;
accessing a customer specific local input parameter;
processing a plurality of transaction data, milestone events, social media data, and geolocation events; and
based on the processing step, generating a set of remittance suggestions and financial suggestions.

2. The system of claim 1, wherein the user interface interacts with the enterprise payments services bus to request or receive one or more services.

3. The system of claim 2, wherein the one or more services relate to one or more of: payments processing, security services, risk and compliance services, transaction monitoring services and gateway services.

4. The system of claim 1, wherein the set of remittance suggestions and financial suggestions are provided to one or more users via the user interface.

5. The system of claim 1, wherein the set of remittance suggestions and financial suggestions are provided to one or more entities via gateway services.

6. The system of claim 1, wherein the remittance suggestions comprise sending funds to one or more recipients.

7. The system of claim 1, wherein the remittance suggestions comprise increasing a frequency of sending funds to one or more recipients.

8. The system of claim 1, wherein the financial suggestions comprise creating one or more finance accounts based on one or more customer preferences.

9. The system of claim 1, wherein the lightweight personalized analytics (LPA) engine is executed to gain insights for customized services in real-time.

10. A method for providing lightweight personalized analytics (LPA), the method comprising the step of:
receiving one or more customer parameters and remittance trends;
accessing, via a remittance data store, one or more LPA metrics; the LPA metrics comprising a maximum number of local inputs, external inputs and financial inputs, wherein the remittance data store stores and manages LPA metrics;
accessing a customer specific local input parameter;
processing, via a lightweight personalized analytics engine, a plurality of transaction data, milestone events, social media data, and geolocation events; and
based on the processing step, generating, via a user interface, a set of remittance suggestions and financial suggestions, wherein the user interface receives one or more inputs via an enterprise payments services bus.

11. The method of claim 10, wherein the user interface interacts with an enterprise payments services bus to request or receive one or more services.

12. The method of claim 11, wherein the one or more services relate to one or more of: payments processing, security services, risk and compliance services, transaction monitoring services and gateway services.

13. The method of claim 10, wherein the set of remittance suggestions and financial suggestions are provided to one or more users via the user interface.

14. The method of claim 10, wherein the set of remittance suggestions and financial suggestions are provided to one or more entities via gateway services.

15. The method of claim 10, wherein the remittance suggestions comprise sending funds to one or more recipients.

16. The method of claim 10, wherein the remittance suggestions comprise increasing a frequency of sending funds to one or more recipients.

17. The method of claim 10, wherein the financial suggestions comprise creating one or more finance accounts based on one or more customer preferences.

18. The method of claim 10, wherein the lightweight personalized analytics (LPA) engine is executed to gain insights for customized services in real-time.

19. A computer-readable medium comprising instructions which, when executed by a computer, cause the computer to carry out steps of:
receiving one or more customer parameters and remittance trends;
accessing, via a remittance data store, one or more LPA metrics; the LPA metrics comprising a maximum number of local inputs, external inputs and financial inputs, wherein the remittance data store stores and manages LPA metrics;
accessing a customer specific local input parameter;
processing, via a lightweight personalized analytics engine, a plurality of transaction data, milestone events, social media data, and geolocation events; and
based on the processing step, generating, via a user interface, a set of remittance suggestions and financial suggestions, wherein the user interface receives one or more inputs via an enterprise payments services bus.

20. The computer-readable medium of claim 10, wherein the lightweight personalized analytics (LPA) engine is executed to gain insights for customized services in real-time.
